(19) United States
(12) Patent Application Publication
(10) Pub. No.: US 2017/0293838 A1
(43) Pub. Date: Oct. 12, 2017

(54) DEEP HIGH-ORDER EXEMPLAR LEARNING FOR HASHING AND FAST INFORMATION RETRIEVAL

(71) Applicant: NEC Laboratories America, Inc., Princeton, NJ (US)

(72) Inventor: Renqiang Min, Princeton, NJ (US)

(21) Appl. No.: 15/478,840

(22) Filed: Apr. 4, 2017

Related U.S. Application Data
(60) Provisional application No. 62/318,875, filed on Apr. 6, 2016.

(51) Int. Cl. G06N 3/08; G06N 5/04; G06F 17/30; G06N 3/04

(52) U.S. Cl. CPC G06N 3/08; G06N 3/04; G06N 5/04; G06F 17/30244

(57) ABSTRACT

A system and method are provided for deep high-order exemplar learning of a data set. Feature vectors and class labels are received. Each of the feature vectors represents a respective one of a plurality of high-dimensional data points of the data set. The class labels represent classes for the high-dimensional data points. Each of the feature vectors are processed, using a deep high-order convolutional neural network, to obtain respective low-dimensional embedding vectors within each class. A minimization operation is performed on high-order embedding parameters of the high-dimensional data points to output a set of synthetic exemplars. A binarizing operation is performed on the low-dimensional embedding vectors and the set of synthetic exemplars to output hash codes representing the data set. The hash codes are utilized as a search key to increase the efficiency of a processor-based machine searching the data set.

### RELATED APPLICATION INFORMATION

This application claims priority to U.S. Provisional Patent Application Ser. No. 62/318,875 filed on Apr. 6, 2016, incorporated herein by reference in its entirety.

### BACKGROUND

### Technical Field

The present invention generally relates to information processing and more particularly to deep high-order exemplar learning for hashing and fast information retrieval of large-scale data such as documents, images, and surveillance videos.

### Description of the Related Art

A lot of high-dimensional data such as handwriting samples and natural images usually includes a lot of redundant information with their intrinsic dimensionality being small. Classification in an appropriate low-dimensional space often results in better performance. On the other hand, high-order feature interactions naturally exist in many forms of real-world data, including images, documents, surveillance videos, financial time series, and biomedical informatics data, etc. These interplays often convey essential information about the latent structures of the datasets of interest. It is crucial to capture these high-order characteristic features efficiently in order to learn a powerful feature mapping for dimensionality reduction.

Deep learning models have made promising progresses in terms of generating powerful parametric embedding functions for high-order interactions. Current state-of-the-art deep strategies, however, never use explicit high-order feature interactions to enhance representational efficiency to map high-dimensional data to low-dimensional space. Explicit feature interactions reveal the structural information intuitively understandable to humans and their combination with deep structures are often more efficient than the implicit approaches solely based on deep learning. Furthermore, current embedding methods lack the ability to conduct efficient data summarization capturing essential data variations while generating embedding. Such capability is very desirable when dealing with large scale datasets, in terms of effectively visualizing the data or conducting efficient pairwise computation between data instances.

### SUMMARY

According to an aspect of the present principles, a computer-implemented method is provided for deep high-order exemplar learning of a data set. The method includes receiving, by a processor, feature vectors and class labels, each of the feature vectors being representative of a respective one of a plurality of high-dimensional data points of the data set, the class labels representing classes for the high-dimensional data points. The method further includes processing, by the processor using a deep high-order convolutional neural network, each of the feature vectors to obtain respective low-dimensional embedding vectors. The method also includes performing, by the processor, a minimization operation on high-order embedding parameters of the high-dimensional data points to output a set of synthetic exemplars within each class that have (i) high-order feature interactions representative of the class labels and (ii) data separation properties in low-dimensional space. The method additionally includes performing, by the processor, a binarizing operation on the low-dimensional embedding vectors and the set of synthetic exemplars to output hash codes representing the data set. The method also includes utilizing, by the processor, the hash codes as a search key to increase the efficiency of a processor-based machine when retrieving one or more images or one or more documents from the data set.

According to another aspect of the present principles, a computer program product is provided for deep high-order exemplar learning of a data set. The computer program product includes a non-transitory computer readable storage medium having program instructions embodied therewith. The program instructions are executable by a computer to cause the computer to perform a method. The method includes receiving, by a processor, feature vectors and class labels, each of the feature vectors being representative of a respective one of a plurality of high-dimensional data points of the data set, the class labels representing classes for the high-dimensional data points. The method further includes processing, by the processor using a deep high-order convolutional neural network, each of the feature vectors to obtain respective low-dimensional embedding vectors. The method also includes performing, by the processor, a minimization operation on high-order embedding parameters of the high-dimensional data points to output a set of synthetic exemplars within each class that have (i) high-order feature interactions representative of the class labels and (ii) data separation properties in low-dimensional space. The method additionally includes performing, by the processor, a binarizing operation on the low-dimensional embedding vectors and the set of synthetic exemplars to output hash codes representing the data set. The method also includes utilizing, by the processor, the hash codes as a search key to increase the efficiency of a processor-based machine when retrieving one or more images or one or more documents from the data set.

According to yet another aspect of the present principles, a system is provided for deep high-order exemplar learning of a data set. The system includes a processor. The processor is configured to receive feature vectors and class labels, each of the feature vectors being representative of a respective one of a plurality of high-dimensional data points of the data set, the class labels representing classes for the high-dimensional data points. The processor is further configured to process, using a deep high-order convolutional neural network, each of the feature vectors to obtain respective low-dimensional embedding vectors. The processor is additionally configured to perform a minimization operation on high-order embedding parameters of the high-dimensional data points to output a set of synthetic exemplars within each class that have (i) high-order feature interactions representative of the class labels and (ii) data separation properties in low-dimensional space. The processor is additionally configured to perform a binarizing operation on the low-dimensional embedding vectors and the set of synthetic exemplars to output hash codes representing the data set. The processor is also configured to utilize the hash codes as a search key to increase the efficiency of a processor-based machine when retrieving one or more images or one or more documents from the data set.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram of an exemplary processing system to which the present invention may be applied, in accordance with an embodiment of the present invention;

FIG. 2 shows a block diagram of an exemplary environment to which the present invention can be applied, in accordance with an embodiment of the present invention;

FIG. 3 shows a high-level block/flow diagram of an exemplary deep high-order convolutional neural network method, in accordance with an embodiment of the present invention;

FIG. 4 shows a block diagram of a high-order convolutional feature map process, in accordance with an embodiment of the present invention;

FIG. 5 is a flow diagram illustrating a method for deep high-order exemplar learning, in accordance with an embodiment of the present invention; and

FIG. 6 shows a block diagram of a shallow high-order parametric embedding with sigmoid layer, in accordance with an embodiment of the present invention.

### DETAILED DESCRIPTION OF PREFERRED EMBODIMENTS

To address the above mentioned challenges, a supervised Deep High-Order Exemplar Learning (DHOEL) approach is used. The purposes of DHOEL are two-fold: simultaneously learning a deep convolutional neural network with novel high-order convolutional filters for dimensionality reduction and constructing a small set of synthetic exemplars to represent the whole input dataset. The strategy targets supervised dimensionality reduction with two new techniques. Firstly, it deploy a series of matrices to model the high-order interactions in the input space. As a result, the high-order interactions can not only be preserved in the low-dimensional embedding space, but they can also be explicitly represented by these interaction matrices. Consequently, one can visualize the explicit high-order interactions hidden in the data.

An exemplar learning technique is employed to jointly create a small set of high-order exemplars to represent the entire data set when optimizing the embedding. As a result, one can just visualize these exemplars, instead of the whole data set, to gain insight into the characteristic features of the data. This is particularly important when the data set is massive. Also, expensive computations done on large data sets, such as pairwise neighborhood computations, can be effectively approximated by using this small set of synthetic exemplars. Consequently, the computational complexity of distance metric computations are reduced from quadratic to linear. The matrix factorization technique can be leveraged to power a high-order convolution to scale to large-scale datasets with high dimensionality.

Data embedding and visualization methods fall into two main categories, i.e, linear strategies and non-linear approaches. Unlike other strategies, DHOEL produces low-dimensional embedding by explicitly capturing high-order interactions when performing convolution operations, thus bearing enhanced interpretable properties. Moreover, DHOEL synthesizes a small number of exemplars conveying high-order interactions to represent the entire data set while learning the low-dimensional embedding. It is worth noting that, DHOEL with exemplar learning is similar to but intrinsically different from stochastic neighbor compression (SNC). Specifically, learning exemplars in High-Order Parametric Embedding (HOPE) for constructing an embedding mapping that optimizes an objective function of maximally collapsing classes instead of neighborhood component analysis. In particular, unlike in SNC, the exemplar learning in HOPE is coupled with high-order embedding parameter learning. Such joint optimization results in three main benefits. Firstly, the joint learning powers the exemplars created to capture essential data variations bearing high-order interactions. Secondly, the coupled learning significantly stabilizes the learning dynamics. Finally, learned exemplars in DHOEL help achieve tens of thousands of speedups, instead of hundreds of speedups as in SNC.

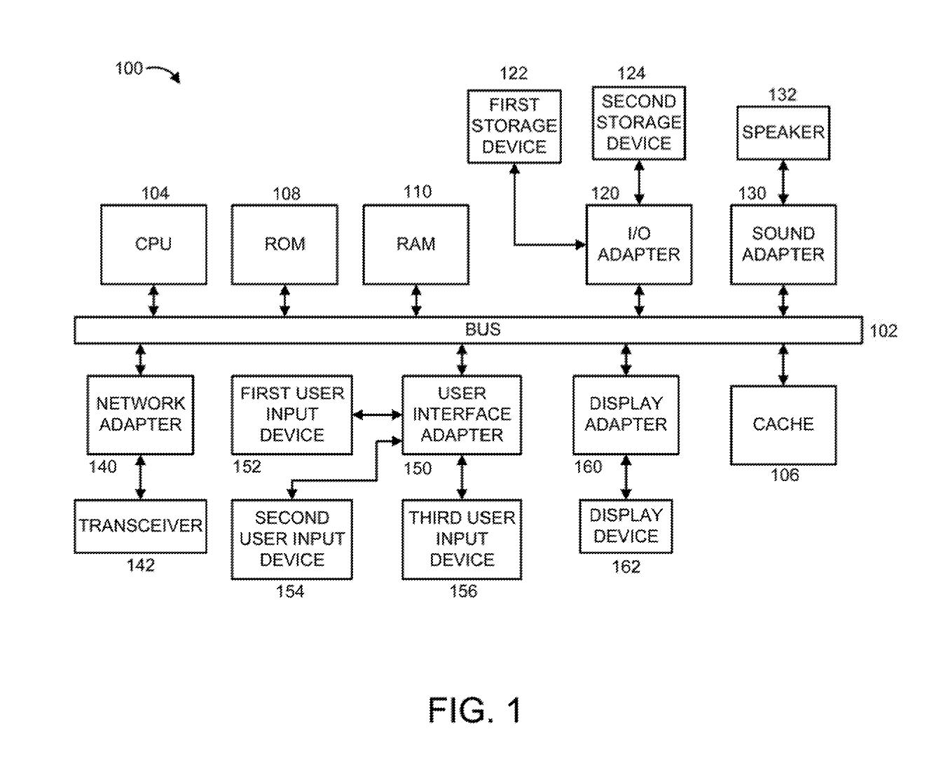

FIG. 1 shows a block diagram of an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. The speaker 132 can be used to provide an audible alarm or some other indication relating to resilient battery charging in accordance with the present invention. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

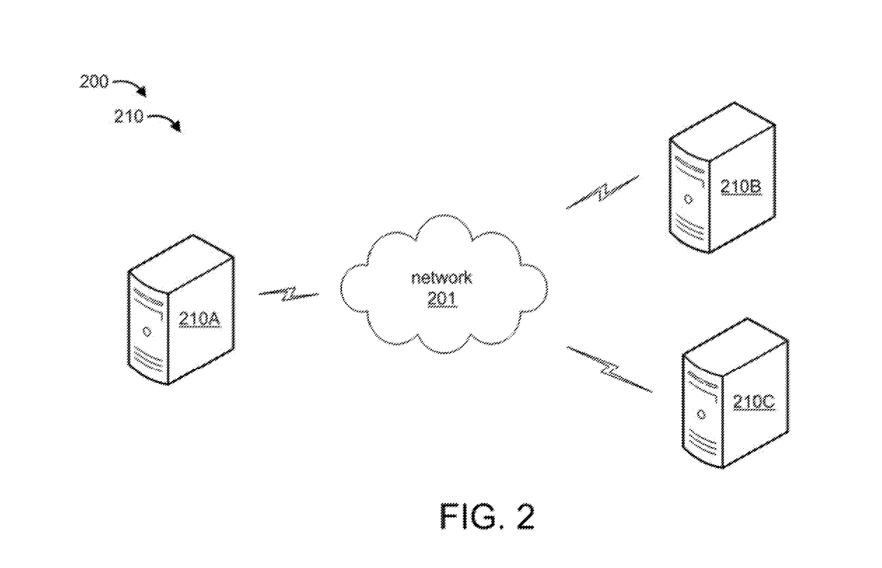

Moreover, it is to be appreciated that environment 200 described below with respect to FIG. 2 is an environment for implementing respective embodiments of the present invention. Part or all of processing system 100 may be implemented in one or more of the elements of environment 200.

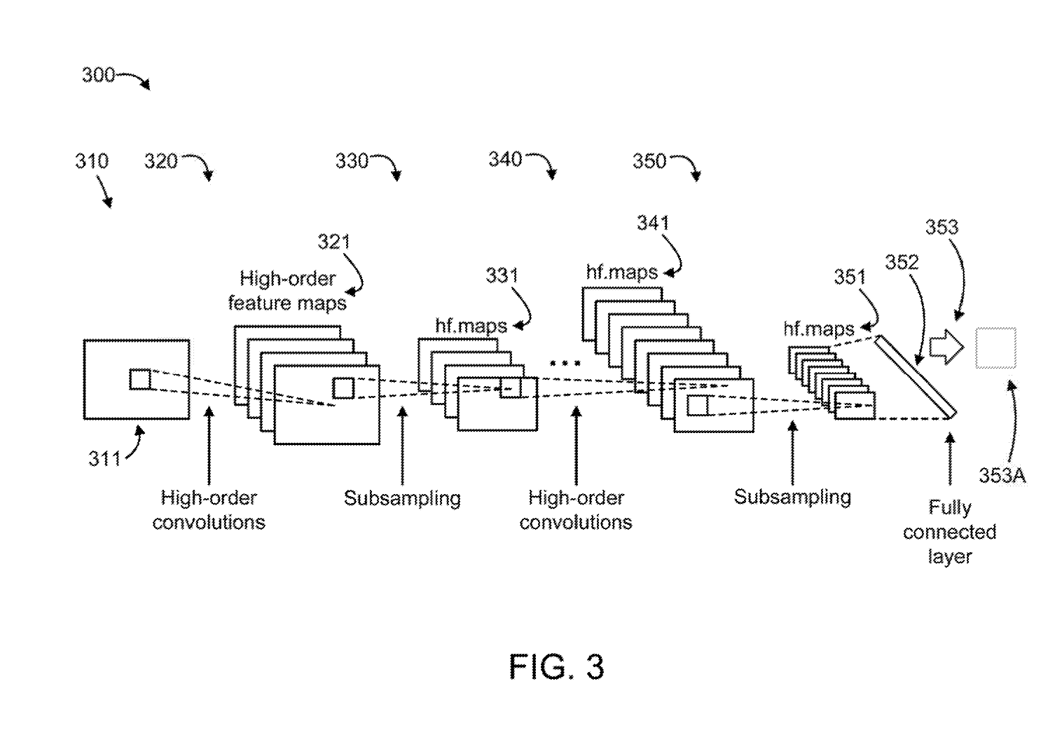

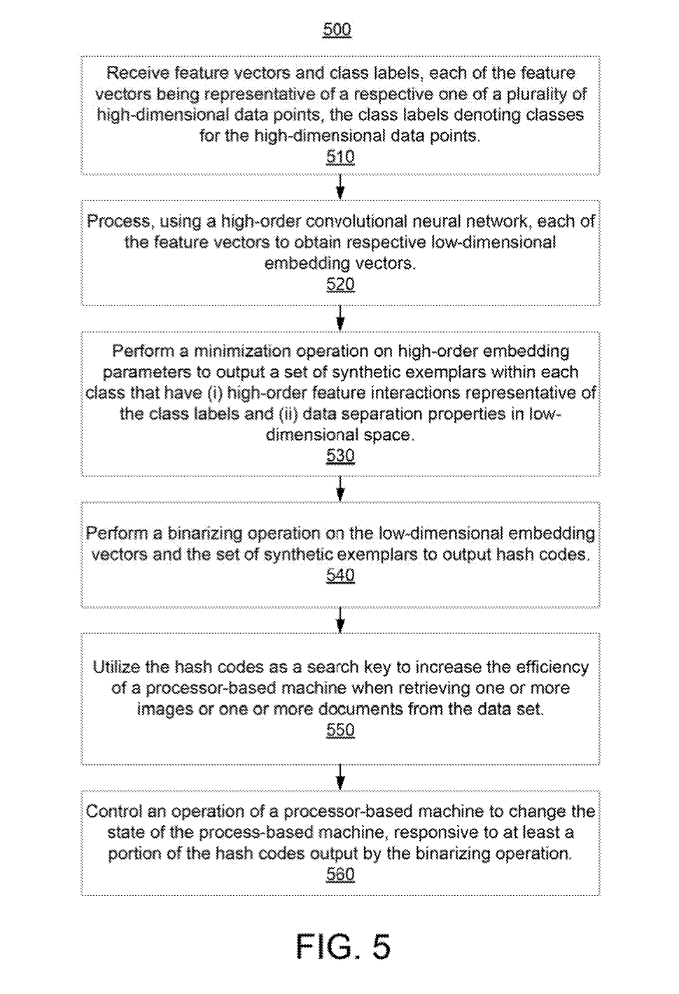

Further, it is to be appreciated that processing system 100 may perform at least part of the method described herein including, for example, at least part of method 300 of FIG. 3 and/or at least part of method 500 of FIG. 5. Similarly, part or all of system 200 may be used to perform at least part of method 300 of FIG. 3 and/or at least part of method 500 of FIG. 5.

FIG. 2 shows an exemplary environment 200 to which the present invention can be applied, in accordance with an embodiment of the present invention. The environment 200 is representative of a computer network to which the present invention can be applied. The elements shown relative to FIG. 2 are set forth for the sake of illustration. However, it is to be appreciated that the present invention can be applied to other network configurations as readily contemplated by one of ordinary skill in the art given the teachings of the present invention provided herein, while maintaining the spirit of the present invention.

The environment 200 at least includes a set of computer processing systems 210. The computer processing systems 210 can be any type of computer processing system including, but not limited to, servers, desktops, laptops, tablets, smart phones, media playback devices, and so forth. For the sake of illustration, the computer processing systems 210 include server 210A, server 210B, and server 210C.

In an embodiment, the present invention performs deep high-order exemplar learning for large data sets for any of the computer processing systems 210. Thus, any of the computer processing systems 210 can perform data compression in both feature and sample spaces for learning from large scale datasets that can be stored in, or accessed by, any of the computer processing systems 210. Moreover, the output (including hash codes) of the present invention can be used to control other systems and/or devices and/or operations and/or so forth, as readily appreciated by one of ordinary skill in the art given the teachings of the present invention provided herein, while maintaining the spirit of the present invention.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

FIG. 3 shows a high-level block/flow diagram of an exemplary deep high-order convolutional neural network method 300, in accordance with an embodiment of the present invention.

At step 310, receive an input image or a synthetic exemplar 311.

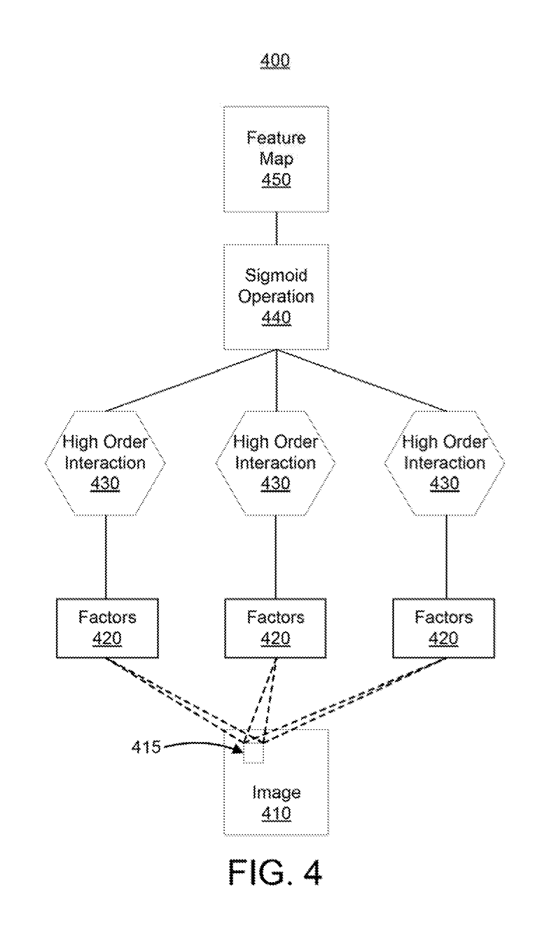

At step 320, (with one embodiment of step 320 shown in FIG. 4) perform high-order convolutions on the input image or the synthetic exemplar 311 to obtain high-order feature maps 321.

At step 330, perform sub-sampling on the high-order feature maps 321 to obtain a set of hf.maps 331.

At step 340, perform high-order convolutions on the set of hf.maps 331 to obtain another set of hf.maps 341.

At step 350, perform sub-sampling on the other set of hf.maps 341 to obtain yet another set of hf.maps 351 that form a fully connected layer 352. The fully connected layer 352 provides a continuous or binarized output low-dimensional embedding vector 353A after a linear transform 353.

It is to be appreciated that the neurons in the fully connected layer 352 have full connections to all activations in the previous layer. Their activations can hence be computed with a matrix multiplication followed by a bias offset.

We can optionally have more fully connected layers rather than just 352 and more repeated steps of 320 and 330 rather than just 340 and 350 depending on different tasks

It is to be further appreciated that while a single image is mentioned with respect to step 310, multiple images such as in the case of one or more video sequences can be input and processed in accordance with the method 300 of FIG. 3, while maintaining the spirit of the present invention.

Referring now to FIG. 4, a high-order convolutional feature map process 400 is illustratively shown. The high-order convolutional feature map process 400 may be used as step 320 of FIG. 3. The high-order convolutional feature map process 400 may include an image 410. The image 410 may include one or more patches 415 (hereafter “patch”). The patch 415 may feed in into more than one factors (individually and collectively denoted by the figure reference 420). The more than one factors 420 may pass a factorized patch 415 to one or more high order interactions (individually and collectively denoted by the figure reference 430). The one or more high order interactions 430 may pass a processed factorized patch 415 to a sigmoid operation 440. The sigmoid operation 440 may output a feature map 450.

Referring to FIG. 5, a flow chart for a deep high-order exemplar learning method 500 is illustratively shown, in accordance with an embodiment of the present invention. In block 510, receive feature vectors and class labels, each of the feature vectors being representative of a respective one of a plurality of high-dimensional data points of the data set, the class labels representing classes for the high-dimensional data points. In block 520, process, using a deep high-order convolutional neural network, each of the feature vectors to obtain respective low-dimensional embedding vectors. In block 530, perform a minimization operation on high-order embedding parameters of the high-dimensional data points to output a set of synthetic exemplars within each class that have (i) high-order feature interactions representative of the class labels and (ii) data separation properties in low-dimensional space. A low-dimensional space may be 2 or less dimensions. In block 540, perform a binarizing operation on the low-dimensional embedding vectors and the set of synthetic exemplars to output hash codes representing the data set. The binarizing operation uses a value for each element of the low-dimensional embedding vectors generated by the high-order convolutional neural network, if the value is nonnegative, we output +1, otherwise, −1. In block 550, utilize the hash codes as a search key to increase the efficiency of a processor-based machine when retrieving one or more images or one or more documents from the data set. In block 560, control an operation of a processor-based machine to change the state of the process-based machine, responsive to at least a portion of the hash codes output by the binarizing operation. For example, the hash codes may increase the efficiency of the processor-based machine by allowing the processor-based machine to retrieve image or documents from a large data set at a much improved rate. The increase of efficiency in the processor-based machine may be from the processor-based machine requiring fewer clock cycles to complete the more efficient hash codes based search of the data set or each clock cycle of the processor-based machine may accomplish more with the more efficient hash codes based search. It may also require less bandwidth over a network, as the processor-based machine may not need to pull the complete data set being searched from a remote location, if the data set is located remotely.

Another exemplary embodiment may include the hash codes showing an impending failure by the hash codes showing that the data set is corrupted, in which case the processor/computer-based machine may be controlled to shut offa device or portion of a device or an application running thereon that will likely fail soon. These and other types of operations are readily determined by one of ordinary skill in the art, given the teachings of the present invention provided herein, while maintaining the spirit of the present invention.

Given a set of data points D=(x⁽ⁱ⁾, y⁽ⁱ⁾: i=1, . . . , n), where xⁱεR^{H}, yⁱε {1, . . . , c} for labeled data points, and c is the total number of classes. HOPE is configured to find a high-order parametric embedding function ƒ(x⁽ⁱ⁾) that transforms the high-dimensional data point xᵢ to a latent space with h(h<H) dimensions by optimizing the objective function of Neighborhood Component Analysis (NCA). Thereby, two main goals are achieved: (1) data points in the same class stay tightly close to each other; (2) data points in different classes stay farther apart from each other. The data points in the same class that stay tightly close to each other remain within a predetermined distance to each other in the high-dimensional space. A high-dimensional space may be 3 or more dimensions. The pairwise similarity of data points in the transformed space can be computed by deploying a stochastic neighborhood criterion. In this setting, the similarity of two data points ƒ(x⁽ⁱ⁾) and ƒ(x^{(j)}) are measured by a probability q_{j|i}. The q_{j|i} indicates the chance of the data point ƒ(x⁽ⁱ⁾) assigns ƒ(x⁽ⁱ⁾) as its nearest neighbor in the latent embedding space. Then a heavy-tailed t-distribution is used to compute q_{j|i} for supervised embedding due to its capabilities of reducing overfitting, creating tight clusters, increasing class separation, and easing gradient optimization. Formally, this stochastic neighborhood metric first centers a t-distribution over ƒ(x⁽ⁱ⁾), and then computes the density of ƒ(x^{(j)}) under the distribution as follows:

$$\begin{matrix}{q}_{j \vert i} = \frac{{( 1 + \frac{{d}_{ij}}{α} )}^{- \frac{1 + α}{2}}}{{{Σ}_{kl \text{:} k \neq l} ( 1 + \frac{{d}_{ij}}{α} )}^{- \frac{1 + α}{2}}} , {q}_{il} = 0 , & ( 1 ) \\ {d}_{ij} = \vert \vert f ( {x}^{i} ) - f ( {x}^{j} ) {\vert \vert}^{2} , & ( 2 )\end{matrix}$$

where α is a parameter representing the degree of freedom. It is worth noting that when α approaches infinity, the t-distribution will approach a unit Gaussian distribution. Here α=1 works very well in practice for supervised two-dimensional embedding. For d-dimensional embedding (d>2), we often set α=d−1. ƒ represents the nonlinear function mapping by the deep high-order convolutional neural network.

For each input data point iε(1, . . . , n), the parameters of DHOEL including the parameters of the deep high-order convolutional neural network and the exemplars are learned by maximizing the sum of conditional probabilities q_{j|i} of choosing all other data points j in the same class as neighbors, where q_{j|i} is computed in the low-dimensional latent space. Formally, the objective function of the DHOEL is as follows:

$$𝓁 = - {\sum }_{i = 1}^{n} log {\sum }_{j = 1 \text{:} j \neq 1}^{n} [ {y}_{i} = {y}_{j} ] {q}_{j \vert i} , \qquad ( 3 )$$

where [·] is an indicator function, [yₗ=yⱼ] equals 1 if yᵢ=yⱼ and 0 otherwise. The above objective function essentially maximizes the sum of pairwise probabilities between data points in the same class, which results in spread-out clusters in low-dimensional code space and is often good for preserving the original cluster patterns in high-dimensional space. Although this approach shares the same objective function with NCA, it learns a deep model with high-order convolutions.

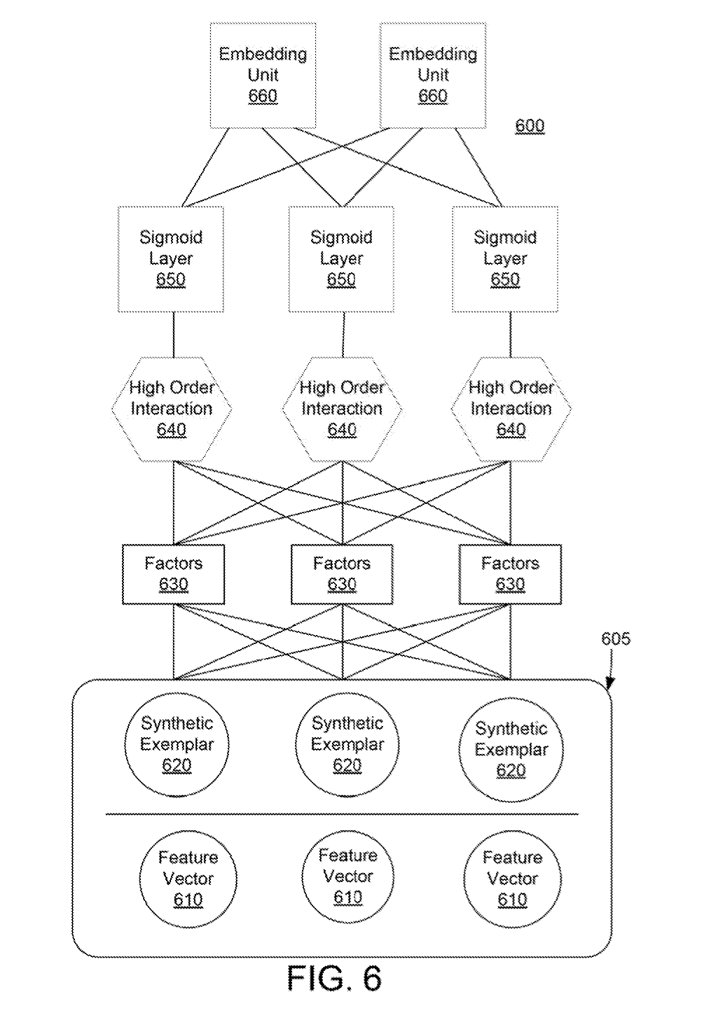

The shallow version of this approach is termed as shallow HOPE. Shallow HOPE's purpose is to parameterize the transformation function ƒ(·): R^{H}→R^{h} by means of matrix computations. The structure of the shallow HOPE method is depicted in FIG. 6.

Referring now to FIG. 6, a shallow high-order parametric embedding with sigmoid layer system 600 is illustratively shown. In one embodiment, the shallow high-order parametric embedding with sigmoid layer system 600 may include a learning process 605. The learning process 605 may include one or more feature vectors (individually and collectively denoted by the figure reference 610) and one or more synthetic exemplars (individually and collectively denoted by the figure reference 620). The learning process 605 may pass the one or more feature vectors 610 and the one or more synthetic exemplars 620 to the one or more factors (individually and collectively denoted by the figure reference 630). The more than one factors 630 may pass a factorized one or more feature vectors 610 and a factorized one or more synthetic exemplars 620 to one or more high order interactions (individually and collectively denoted by the figure reference 640). In one embodiment, the one or more high order interactions 640 may pass a processed factorized one or more feature vectors 610 and a processed factorized one or more synthetic exemplars 620 to one or more embedding units (individually and collectively denoted by the figure reference 660). In another embodiment, the high-order parametric embedding system may include a sigmoid layer (individually and collectively denoted by the figure reference 650). The one or more high order interactions 640 may pass a processed factorized one or more feature vectors 610 and a processed factorized one or more synthetic exemplars 620 to one or more sigmoid layers 650. The one or more sigmoid layers 650 may pass a sigmoidized processed factorized one or more feature vectors 610 and a sigmoidized processed factorized one or more synthetic exemplars 620 to one or more embedding units 660.

The transformation function ƒ(x) in shallow HOPE consists of a series of interaction matrices which aim at capturing high-order interplays in the input feature space. The function ƒ capturing second-order interactions has the following form:

$$f ( x ) = {P}^{T} [ \begin{matrix}{( x - {μ}_{1} )}^{T} {S}_{1} ( x - {μ}_{1} ) \\ ⋮ \\ {( x - {μ}_{m} )}^{T} {S}_{m} ( x - {μ}_{m} )\end{matrix} ] , \qquad ( 4 )$$

where xεR^{H} is the input feature vector, ƒ(x)εR^{h} is the resulted embedding vector, and PεR^{m×2} is a projection weight matrix. Also, Sₖ(kε1 . . . m) is a set of m interaction matrices, and correspondingly, μₖ is a set of vectors. The number m indicates how many interaction matrices should be used to capture the interactions in the input space, and each of these matrices learns complementary high-order interactions. It is worth noting that, the μₖ here is introduced in order to enable the model to capture lower-order terms of the interactions. As a result, with the transformation form as depicted in Equation 4, both the first and second order interactions in the data can be modelled. Intuitively, the μₖ here can be considered as the centroids of a set of clusters in the input.

With the parametric form as presented in Equation 4, we can compute the high-order interaction in the input space explicitly. On the other hand, this parametric form introduces too many parameters to the model. In order to reduce the computational complexity of the model, we deploy a matrix factorization technique. The computation of Sₖ can be approximated by the weighted sum of F rank-1 matrices, indexed by ƒ, and each is computed by the outer-product of a filter vector C_{ƒ}εR^{H}:

$${S}_{k} = {\sum }_{f = 1}^{F} {w}_{kf} ( {C}_{kf} {C}_{kf}^{T} ) , \qquad ( 5 )$$

where F is a user-specified parameter indicating the number of factors used in the matrix factorization and w_{kƒ} is the weight associated with the ƒ-th rank-1 interaction matrix C_{kƒ}C_{kƒ}^{T}.

It is worth noting that, the above transformation form not only reduces computational complexity significantly, but also is amenable to explicitly model different order of interaction in the data. That is, for higher-order interaction O, the Equation 4 will bear the following form:

$$f ( x ) = {P}^{T} [ \begin{matrix}{\sum }_{f = 1}^{F} {{w}_{1 f} ( {C}_{1 f}^{T} ( x - {μ}_{1} ) )}^{O} \\ ⋮ \\ {\sum }_{f = m}^{F} {{w}_{mf} ( {C}_{mf}^{T} ( x - {μ}_{m} ) )}^{O}\end{matrix} ] . \qquad ( 6 )$$

Please note that bias terms are not required here due to the nice property of linear projection for embedding. This shallow high-order model shows strong interpretability for data visualization. Firstly, by defining specific value of O, the shallow HOPE enables one to visualize different order of feature interactions hidden in the data. Secondly, the μₖ here can be considered as the centroid point for a cluster in the input data. That is, the input data can be clustered into m groups, and each centers at a learned μ. Finally, the term (x−μ₁)⁰ shows exactly how the high-order features are constructed for dimension reduction. m may be set to 2 for interpretability reasons.

The above shallow high-order method has an explicit high-order parametric form for mapping. In fact, it is essentially equivalent to a linear model with all explicit high-order feature interactions expanded. Compared to supervised deep embedding methods with complicated deep architectures, the above shallow HOPE method has limited modeling power. Fortunately, there is a very simple way to significantly enhance the model's expressive power, by simply adding a Sigmoid transformation to the above shallow HOPE model. We use the Sigmoid transformed shallow HOPE (S-HOPE) to replace the linear convolutional operation in a Deep Convolutional Neural Network, and we call the resulting convolutional operation a high-order convolution. S-HOPE is depicted in FIG. 6.

The key component of high-order convolution, S-HOPE, is the element-wise Sigmoid transformation by σ(·). We simply add a Sigmoid function on top of each weighted combination of high-order terms in shallow HOPE and make C_{kƒ}=C_{ƒ} for all k=1, . . . , m. As a result, Equation 6 becomes:

$$f ( x ) = {P}_{σ}^{T} [ \begin{matrix}{\sum }_{f = 1}^{F} {{w}_{1 f} ( {C}_{f}^{T} ( x - {μ}_{1} ) )}^{O} + {b}_{1} \\ ⋮ \\ {\sum }_{f = m}^{F} {{w}_{mf} ( {C}_{f}^{T} ( x - {μ}_{m} ) )}^{O} + {b}_{m}\end{matrix} ] . \qquad ( 7 )$$

Furthermore, this equation can be rewritten in a matrix form, so that we can get rid of the μ terms to favor efficient matrix computations:

$$f ( x ) = {P}_{σ}^{T} [ \begin{matrix}{\sum }_{f = 1}^{F} {{w}_{1 f} ( {C}_{f}^{′ T} {x}^{′} )}^{O} + {b}_{1} \\ ⋮ \\ {\sum }_{f = m}^{F} {{w}_{mf} ( {C}_{f}^{′ T} {x}^{′} )}^{O} + {b}_{m}\end{matrix} ] . \qquad ( 8 )$$

In other words, in this rewritten form, the parameter μₖ has been merged into the new weight matrices C′_{ƒ}^{T}, where x′=[x; 1] and C′_{ƒ}R^{H+1}.

S-HOPE dramatically improves the modeling power of shallow HOPE. By simply adding a sigmoid function, this shallow high-order parametric method even significantly outperforms the state-of-the-art deep learning models with many layers for supervised embedding, which clearly demonstrates the representational power of shallow models with high-order feature interactions. The Deep High-Order Convolutional Neural Network with a high-order kernel parameterized by S-HOPE is much more powerful than a traditional Deep Convolutional Neural Network.

In addition to identifying explicit high-order feature interactions in training data, the shallow HOPE framework can also synthesize a small set of exemplars that do not exist in the training set. Suppose we have the same set of data points D={x⁽ⁱ⁾, y⁽ⁱ⁾: i=1, . . . , n}, where x⁽ⁱ⁾εR^{H}, y⁽ⁱ⁾ε{1, . . . , c} as described above. Shallow HOPE's purpose is to learn s exemplars per class with their designated class labels fixed, where s is a user-specified free parameter and s×x=z<<n. We denote these exemplars by {e^{(ƒ)}: j=1, . . . , z}. When performing the joint learning of embedding parameters and exemplars, we optimize the following objective function,

$${min}_{θ , \{ {e}_{j} \}} 𝓁 ( θ , \{ {e}_{j} \} ) = - {\sum }_{l = 1}^{n} log {\sum }_{j = 1}^{z} [ {y}_{i} = {y}_{j} ] {q}_{j \vert i} , \qquad ( 9 )$$

where i indexes training data points, j indexes exemplars, θ denotes the high-order embedding parameters, p_{j|i} is calculated in the same way as above, and q_{j|i} is calculated as follows,

$$\begin{matrix}{q}_{j \vert i} = \frac{{( 1 + \frac{{d}_{ij}}{α} )}^{- \frac{1 + α}{2}}}{{\sum }_{k = 1}^{z} {( 1 + \frac{{d}_{ik}}{α} )}^{- \frac{1 + α}{2}}} , & ( 10 ) \\ {d}_{ij} = \vert \vert f ( {x}^{( i )} ) - f ( {e}^{( j )} ) {\vert \vert}^{2} . & ( 11 )\end{matrix}$$

Please note that, unlike the symmetric probability distribution in Equation 1, the asymmetric q_{j|i} here is computed only using the pairwise distances between training data points and exemplars. Because z<<n, it saves a lot of computations compared to using the original distribution in Equation 1. The derivative of the above objective function with respect to exemplar e^{(j)} is as follows,

$$\frac{\partial 𝓁 ( θ , {e}_{j} )}{\partial {e}^{( j )}} = {\sum }_{i = 1}^{n} \frac{( α + 1 )}{α} {( 1 + \frac{{d}_{ij}}{α} )}^{- 1} \times ( {p}_{j \vert i} - {q}_{j \vert i} ) ( f ( {e}^{( j )} ) - f ( {x}^{( i )} ) ) \frac{\partial f ( {e}^{( j )} )}{\partial {e}^{( j )}} . \qquad ( 12 )$$

The derivatives of other model parameters can be easily calculated similarly. We update these synthetic exemplars and the embedding parameters of shallow HOPE in a deterministic Expectation-Maximization fashion using Conjugate Gradient Descent, as is shown in Process 1. Specifically, the s exemplars belonging to each class are initialized by random sampling or k-means clustering within that particular data class. During the early phase of the joint optimization of exemplars and high-order embedding parameters, the learning process alternatively fixes one while updating the other. Then the process updates all the parameters simultaneously until reaching convergence or the specified maximum number of epochs. For shallow HOPE with exemplar learning, we set α=1.

### Process 1 Deep High-Order Exemplar Learning

1: Initializing parametric embedding parameters 0 randomly and initializing the specified number of exemplars {e^{(j)}}ⱼ₌₁^{z} by performing random data sampling or k-means clustering for each class.
2: for epoch t=1, . . . , T do
3: if t<Tₛ then
4: if t mod 2=1 then
5: Update embedding parameters using current exemplars
6: else
7: Update exemplars using current embedding parameters or fix the exemplars to the k-means clusters of each class
8: end if
9: else
10: update exemplars and embedding parameters simultaneously, using conjugate gradient descent, or fix the exemplars to the k-means clusters of each class and update the embedding parameters using conjugate gradient descent
11: end if
12: end for

With the help of exemplar learning, we can perform fast information retrieval easily by performing large-margin k-nearest neighbor (kNN) classification with respect to the learned exemplars. We optimize the following objective function,

min_{θ}Σᵢₗyᵢₗd(i,l)+CΣᵢₗⱼyᵢₗ(1−yᵢⱼ)h(1+d(i,l)−d(i,j)), (13)

where i indexes training data points, j and l index exemplars, i=1, . . . , n, j=1, . . . , z, l=1, . . . , z, yᵢⱼ=1 if yᵢ=yⱼ and 0 otherwise, C is a penalty coefficient penalizing constraint violations, and h(·) is a hinge loss function with h(z)=max(z, 0).

A novel Supervised High-Order Parametric Embedding approach with explicit high-order feature interactions for data embedding and visualization. Owing to the benefit of exemplar learning, S-HOPE not only attains attractive interpretability, but also jointly synthesizes a set of exemplars to conduct efficient large-scale data summarization capturing essential data variations and to increase computational efficiency by thousands of times for fast kNN classification with matched or exceeded accuracy as in the input space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for deep high-order exemplar learning of a data set, the method comprising:
receiving, by a processor, feature vectors and class labels, each of the feature vectors being representative of a respective one of a plurality of high-dimensional data points of the data set, the class labels representing classes for the high-dimensional data points;
processing, by the processor using a deep high-order convolutional neural network, each of the feature vectors to obtain respective low-dimensional embedding vectors;
performing, by the processor, a minimization operation on high-order embedding parameters of the high-dimensional data points to output a set of synthetic exemplars within each class that have (i) high-order feature interactions representative of the class labels and (ii) data separation properties in low-dimensional space;
performing, by the processor, a binarizing operation on the low-dimensional embedding vectors and the set of synthetic exemplars to output hash codes representing the data set; and
utilizing, by the processor, the hash codes as a search key to increase the efficiency of a processor-based machine when retrieving one or more images or one or more documents from the data set.

2. The computer-implemented method of claim 1, wherein the minimization operation maximally collapses the classes for the high-dimensional data points.

3. The computer-implemented method of claim 2, wherein the maximally collapsed classes for the high-dimensional data points maximize a sum of pairwise probabilities between the high-dimensional data points in a same one of the classes, to spread out clusters in a low-dimensional code space while preserving original cluster patterns in a high-dimensional space.

4. The computer-implemented method of claim 1, wherein the minimization operation includes using a deterministic expectation-maximization method that uses a conjugate gradient descent.

5. The computer-implemented method of claim 1, wherein the feature vectors are output from the deep high-order convolutional neural network based on one or more input images.

6. The computer-implemented method of claim 1, wherein the class labels represent data points within a predetermined distance to each other in a high-dimensional space.

7. The computer-implemented method of claim 1, wherein the deep high-order convolutional neural network uses one or more interaction matrices to capture high-order interactions in an input feature space.

8. The computer-implemented method of claim 1, further comprising controlling an operation of the processor-based machine to change the state of the processor-based machine, responsive to at least a portion of the hash codes output by the binarizing operation.

9. The computer-implemented method of claim 1, wherein the minimization operation to output the set of synthetic exemplars include an operation selected from the group consisting of (i) joint optimization for updating the low-dimensional embedding vectors and the set of synthetic exemplars with new feature vectors and new class labels and (ii) k-means clustering to fix the set of synthetic exemplars to k-means clusters of each class.

10. A computer program product for deep high-order exemplar learning of a data set, the computer program product comprising a non-transitory computer readable storage medium having program instructions embodied therewith, the program instructions executable by a computer to cause the computer to perform a method comprising:
receiving, by a processor, feature vectors and class labels, each of the feature vectors being representative of a respective one of a plurality of high-dimensional data points of the data set, the class labels representing classes for the high-dimensional data points;
processing, by the processor using a deep high-order convolutional neural network, each of the feature vectors to obtain respective low-dimensional embedding vectors;
performing, by the processor, a minimization operation on high-order embedding parameters of the high-dimensional data points to output a set of synthetic exemplars within each class that have (i) high-order feature interactions representative of the class labels and (ii) data separation properties in low-dimensional space;
performing, by the processor, a binarizing operation on the low-dimensional embedding vectors and the set of synthetic exemplars to output hash codes representing the data set; and
utilizing, by the processor, the hash codes as a search key to increase the efficiency of a processor-based machine when retrieving one or more images or one or more documents from the data set.

11. The computer-implemented method of claim 10, wherein the minimization operation maximally collapses the classes for the high-dimensional data points.

12. The computer-implemented method of claim 11, wherein the maximally collapsed classes for the high-dimensional data points maximize a sum of pairwise probabilities between the high-dimensional data points in a same one of the classes, to spread out clusters in a low-dimensional code space while preserving original cluster patterns in a high-dimensional space.

13. The computer-implemented method of claim 10, wherein the minimization operation includes using a deterministic expectation-maximization method that uses a conjugate gradient descent.

14. The computer-implemented method of claim 10, wherein the feature vectors are output from the deep high-order convolutional neural network based on one or more input images.

15. The computer-implemented method of claim 10, wherein the class labels represent data points within a predetermined distance to each other in a high-dimensional space.

16. The computer-implemented method of claim 10, wherein the deep high-order convolutional neural network uses one or more interaction matrices to capture high-order interactions in an input feature space.

17. The computer-implemented method of claim 10, further comprising controlling an operation of the processor-based machine to change the state of the processor-based machine, responsive to at least a portion of the hash codes output by the binarizing operation.

18. The computer-implemented method of claim 10, wherein the minimization operation to output the set of synthetic exemplars include an operation selected from the group consisting of (i) joint optimization for updating the low-dimensional embedding vectors and the set of synthetic exemplars with new feature vectors and new class labels and (ii) k-means clustering to fix the set of synthetic exemplars to k-means clusters of each class.

19. A system for deep high-order exemplar learning of a data set, the system comprising:
a processor, configured to:
receive feature vectors and class labels, each of the feature vectors being representative of a respective one of a plurality of high-dimensional data points of the data set, the class labels representing classes for the high-dimensional data points;
process, using a deep high-order convolutional neural network, each of the feature vectors to obtain respective low-dimensional embedding vectors;
perform a minimization operation on high-order embedding parameters of the high-dimensional data points to output a set of synthetic exemplars within each class that have (i) high-order feature interactions representative of the class labels and (ii) data separation properties in low-dimensional space; and
perform a binarizing operation on the low-dimensional embedding vectors and the set of synthetic exemplars to output hash codes representing the data set; and
utilize the hash codes as a search key to increase the efficiency of a processor-based machine when retrieving one or more images or one or more documents from the data set.

20. The system of claim 19, wherein the minimization operation includes using a deterministic expectation-maximization method that uses a conjugate gradient descent.
